(19) United States
(12) Patent Application Publication
(10) Pub. No.: US 2011/0080466 A1
(43) Pub. Date: Apr. 7, 2011

(54) AUTOMATED PROCESSING OF ALIGNED AND NON-ALIGNED IMAGES FOR CREATING TWO-VIEW AND MULTI-VIEW STEREOSCOPIC 3D IMAGES

(75) Inventors: Eeri Kask, Dresden (DE); Steffen Böttcher, Dresden (DE); Thomas F. El-Maraghi, Hawkestone (CA); Klaus Patrick Kesseler, Hamilton (CA); David Matz, Dresden (DE); Ihor Michael Petelycky, Toronto (CA)

(73) Assignee: SPATIAL VIEW INC., Toronto (CA)

(21) Appl. No.: 12/899,022

(22) Filed: Oct. 6, 2010

Related U.S. Application Data
(60) Provisional application No. 61/272,583, filed on Oct. 7, 2009.

(51) Int. Cl. H04N 13/00

(52) U.S. Cl. 348/43; 348/E13.001

(57) ABSTRACT

A system for creation of stereoscopic 3D images, including a disparity map initializer, for deriving one or more initial disparity maps represented as vector fields of translations between aligned left and right images of a scene, a disparity map generator, coupled with the disparity map initializer, for deriving disparity maps for the aligned left and right images, from the initial disparity maps, and a view renderer, coupled with the disparity map generator, for rendering stereoscopic 3D images, from the aligned left and right images, and from the disparity maps. A method for creating stereoscopic 3D images is also described and claimed.

### CROSS REFERENCES TO RELATED APPLICATIONS

This application claims benefit of U.S. Provisional Application No. 61/272,583, entitled METHOD AND PROCESS FOR THE AUTOMATED PROCESSING AND EDITING OF ALIGNED AND NON-ALIGNED IMAGES FOR THE CREATION OF TWO-VIEW AND MULTI-VIEW STEREOSCOPIC IMAGES, filed on Oct. 7, 2009 by inventors Eeri Kask, Steffen Böttcher, Thomas El-Maraghi, Klaus Kesseler and David Matz.

### FIELD OF THE INVENTION

The field of the present invention is stereo 3D imaging.

### BACKGROUND OF THE INVENTION

Today, most stereo 3D content is created for display on high-resolution large format displays, ranging from HD televisions with screen sizes on the order of 100 inches diagonal, to movie theater displays with screen sizes on the order of 40 ft.×70 ft. However, an increasing demand is evolving to view stereo content on mobile devices, such as laptops, portable game players, media players and smart phones. In 2010, Nintendo released a stereo 3D enabled gaming platform, and it is projected that by 2018 over 70 million mobile phones will be enabled for stereo 3D display.

There are many different stereo 3D viewing technologies available today. Some technologies, referred to as stereoscopic, require special viewing glasses. Examples of stereoscopic technologies include shutter and polarized displays. Other technologies, referred to as auto-stereoscopic, do not require special viewing glasses. Examples of auto-stereoscopic technologies include active and passive barrier, and lenticular overlay displays. Yet other technologies require special accessories such as 3D headgear and anaglyph glasses.

Conventional processes for creating stereoscopic 3D images are of two types; namely, (i) during capture of a left and a right image of a scene, and (ii) post processing. Stereoscopic 3D image processing during image capture is generally performed in one of four ways. The stereoscopic 3D image processing may be performed using a camera that has two lenses and two sensors. The camera maintains a constant relationship between two captured images. The stereoscopic 3D image processing may also be performed using a camera that has a beam splitter or other such device that splits a captured image into two parts and writes to a single sensor. The stereoscopic 3D image processing may also be performed using two mounted cameras triggered to capture an image simultaneously. The stereoscopic 3D image processing may also be performed by moving a camera and capturing images along a pre-calibrated path.

Stereoscopic 3D image post processing generally uses one or more of a number of software applications that require a trained professional with 3D imaging expertise, who manually applies graphic operations to achieve a desired result.

The current state of the art of 3D imaging does not have an automated way to enhance stereo quality of a manually captured image and to edit perceived depth of a stereoscopic image, without modifying the basic stereo composition.

It would thus be of advantage to have an automated workflow for creating stereoscopic 3D images from captured images, that does not require a special camera or a trained professional, and that corrects for errors and anomalies introduced by a user or by a capture device.

It would further be of advantage to have an automated workflow that enables enhancing stereo quality of a manually captured image and to edit perceived depth of a stereoscopic image, without having to modify the basic stereo composition.

### SUMMARY OF THE DESCRIPTION

Aspects of the present invention provide systems and methods to automate creation of stereoscopic 3D images from two captured images of a scene; namely, a left image and a right image. The systems and methods of the present invention do not require a special camera or such other special capture device, and may be used by a non-professional, who does not have 3D imaging expertise. The systems and methods of the present invention employ an image pre-processor and an image rectifier to correct for user or device introduced errors and anomalies.

The stereoscopic 3D images created by the present invention may be displayed for viewing, and may also be printed. The stereoscopic images created by the present invention may be of any type, known today or in the future, that may be viewed with or without a display overlay, with or without glasses, and with or without 3D headgear, including inter alia two-view images, multi-view images and interlaced images.

Further aspects of the present invention provide a stereo 3D adjuster for enhancing stereo quality of a manually captured image and for editing perceived depth of a stereoscopic image, without having to modify the basic stereo composition.

Further aspects of the present invention provide optimization over image stacks of time-related images, for creation of stereoscopic 3D movies.

There is thus provided in accordance with an embodiment of the present invention a system for creation of stereoscopic 3D images, including a disparity map initializer, for deriving one or more initial disparity maps represented as vector fields of translations between aligned left and right images of a scene, a disparity map generator, coupled with the disparity map initializer, for deriving disparity maps for the aligned left and right images, from the initial disparity maps, and a view renderer, coupled with the disparity map generator, for rendering stereoscopic 3D images, from the aligned left and right images, and from the disparity maps.

There is additionally provided in accordance with an embodiment of the present invention a method for creating stereoscopic 3D images, including deriving initial disparity maps represented as vector fields of translations between aligned left and right images of a scene, deriving disparity maps for the aligned left and right images, from the initial disparity maps, and rendering stereoscopic 3D images, from the aligned left and right images, and from the derived disparity maps.

### BRIEF DESCRIPTION OF THE DRAWINGS

The present invention will be more fully understood and appreciated from the following detailed description, taken in conjunction with the drawings in which:

FIG. 1 is a simplified block diagram of a system for automating a workflow for creating stereoscopic 3D images, in accordance with an embodiment of the present invention;

FIG. 2 is a simplified block diagram of the image pre-processor of FIG. 1, in accordance with an embodiment of the present invention;

FIG. 3 is a simplified block diagram of the image rectifier of FIG. 1, in accordance with an embodiment of the present invention;

FIG. 4 is a simplified block diagram of the disparity map initializer of FIG. 1, in accordance with an embodiment of the present invention;

FIG. 5 is a simplified block diagram of the disparity map generator of FIG. 1, in accordance with an embodiment of the present invention;

FIG. 6 is a simplified block diagram of the stereo 3D adjuster of FIG. 1, in accordance with an embodiment of the present invention;

FIG. 7 is a simplified block diagram of the view generator of FIG. 1, in accordance with an embodiment of the present invention; and

FIG. 8 is a simplified diagram of processing a video sequence of stereo image pairs, in accordance with an embodiment of the present invention.

### DETAILED DESCRIPTION

Aspects of the present invention relate to an automated workflow for creating a stereoscopic 3D image from two captured images of a scene; namely, a left image and a right image. The stereoscopic 3D image may be inter alia a two-view, a mufti-view, an interlaced image, or such type of stereoscopic 3D image, now or in the future, that may be viewed with or without a display overlay, with or without glasses, and with or without 3D headgear.

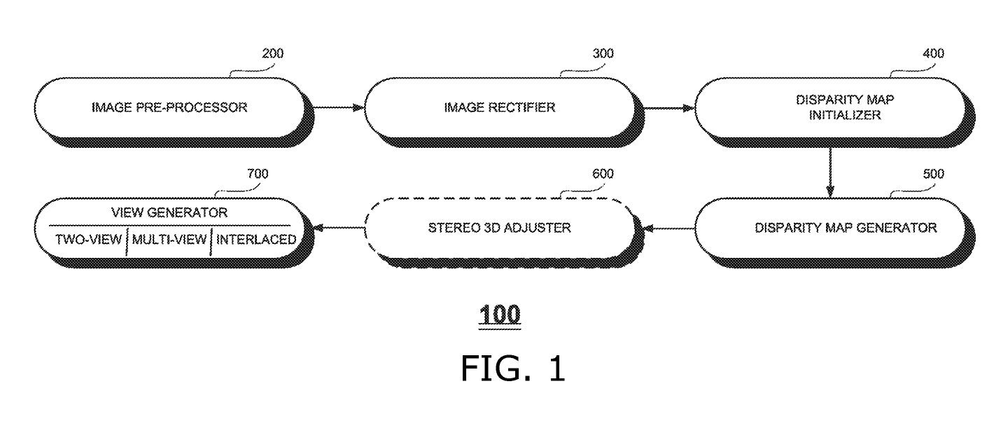

Reference is made to FIG. 1, which is a simplified block diagram of a system 100 for automating a workflow for creating stereoscopic 3D images, in accordance with an embodiment of the present invention. System 100 automates the process of creating a stereoscopic 3D image from left and right images of a scene, captured using a digital camera or such other image or video capture device. The stereoscopic 3D image created by system 100 may be displayed for viewing, and may also be printed.

The left and right images may be captured simultaneously, using a mechanism that maintains a constant alignment of the two images. Alternatively, the images may be captured separately, with or without an alignment device or an alignment assist. As such, the left and right captured images may be aligned or non-aligned. System 100 may be used by a user without 3D imaging expertise, and the system corrects for errors and anomalies introduced by the user or by the capture device.

As shown in FIG. 1, system 100 includes six components; namely, an image pre-processor 200, and image rectifier 300, a disparity map initializer 400, a disparity map generator 500, a stereo 3D adjuster 600 and a view generator 700. Stereo 3D adjuster 600 is optional, and is thus indicated using dashed lines. Each of these components is described in detail hereinbelow.

### Image Pre-Processor 200

Image pre-processor 200 is operative to balance left and right captured images for luminance, color and white balance, and to correct the images for user errors, capture device errors, environmental errors, anomalies and aberrations.

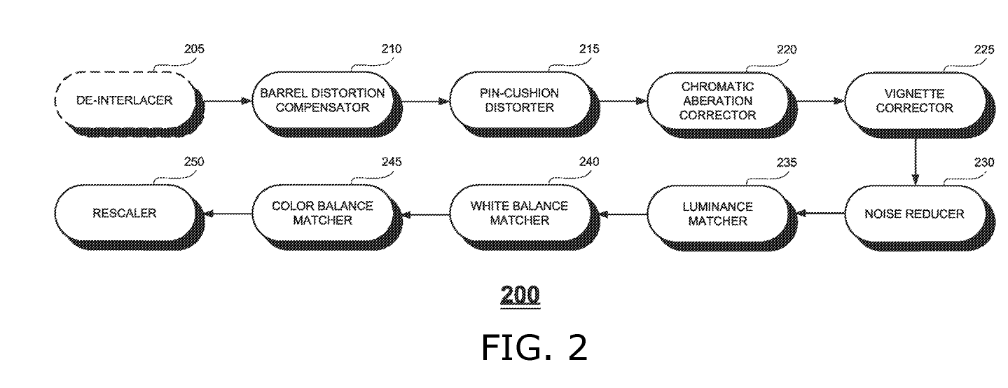

Reference is made to FIG. 2, which is a simplified block diagram of image pre-processor 200, in accordance with an embodiment of the present invention. As shown in FIG. 2, image pre-processor 200 includes ten modules.

A de-interlacer 205 separates left and right interlaced images. De-interlacer 205 is only required when the two captured images are interlaced and, as such, is indicated by dashed lines as being optional.

A barrel distortion compensator 210 corrects for linear distortion, and also for second degree and higher non-linear distortion, caused by a decrease in magnification from an optical axis during image capture. Distortion compensator 210 accepts as input left and right images, referred to herein as a stereo image pair, and generates as output a corrected stereo image pair.

A pin-cushion distorter 215 corrects for linear and also for non-linear distortion, caused by interaction of curvature of a lens with a flat image sensor of the capture device. Pin-cushion distorter 215 accepts as input a stereo image pair, and generates as output a corrected stereo image pair.

A chromatic aberration corrector 220 corrects for aberration caused by dispersion of lens material; i.e., variation of lens refractive index with wavelength of light. Chromatic aberration corrector 220 accepts as input a stereo image pair, and generates as output a corrected stereo image pair.

A vignette corrector 225 corrects for a vignette that is caused by photons hitting sensors positioned at edges at an acute angle. The vignette is manifested by a dark area around the perimeter of an image. Vignette corrector 225 accepts as input a stereo image pair, and generates as output a corrected stereo image pair.

Digital cameras may introduce noise from a variety of sources. A noise reducer 230 corrects for noise in the left and right images. Noise in the images is fully or partially removed, so as not to impact subsequent workflow processes. Noise reducer 230 accepts as input a stereo image pair, and generates as output a corrected stereo image pair.

A luminance matcher 235 matches luminance of the left and right images. Luminance matcher 235 accepts as input a stereo image pair, and generates as output a corrected stereo image pair.

A white balance matcher 240 matches white balance of the left and right images. White balance matcher 240 accepts as input a stereo image pair, and generates as output a corrected stereo image pair.

A color balance matcher 245 matches color balance of the left and right images. Color balance matcher 245 accepts as input a stereo image pair, and generates as output a corrected stereo image pair.

A rescaler 250 matches scales of the left and right images. Rescaler 250 accepts as input a stereo image pair, and generates as output a corrected stereo image pair.

### Image Rectifier 300

Image rectifier 300 is operable to align the left and right images, if they are non-aligned. In one embodiment of the present invention, image rectifier 300 calculates two homographies; namely, one homography for the left image and another homography for the right image. The homographies are determined from a fundamental matrix, which describes the relative orientation of a first camera that captures the left image with respect to a second camera that captures the right image.

The fundamental matrix is determined by identifying coordinates of prominent pixels in the left and right images that correspond to the same point in the scene. A set of multiple such corresponding pixel pairs are used to estimate the fundamental matrix, by a parameter estimation technique such as inter alia Random Sample Consensus (RANSAC). Due to imprecision in pixel coordinates, and to error in correspondences, the estimated fundamental matrix may incorrectly describe the relative orientation of the first camera with respect to the second camera. As such, image rectifier 300 seeks alternative sets of multiple pixel-pairs to estimate alternative fundamental matrices, and then selects one particular fundamental matrix candidate as being the most faithful. The selected most faithful fundamental matrix is generally one that projects most of the prominent pixels in the left image onto corresponding pixels in the right image with least error.

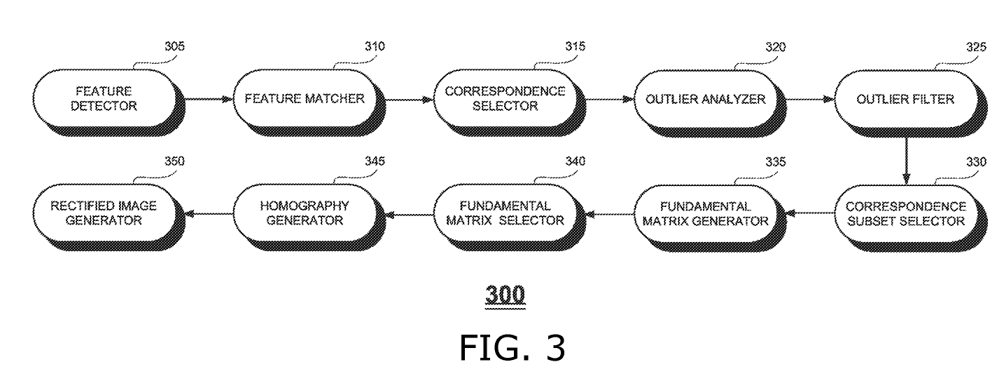

Reference is made to FIG. 3, which is a simplified block diagram of image rectifier 300, in accordance with an embodiment of the present invention. As shown in FIG. 3, image rectifier 300 includes ten modules.

A feature detector 305 extracts local features of the two images. A local feature includes (i) points which are points of interest within an image, and (ii) a descriptor with uniquely identifying information about the points. Local features detected by feature detector 305 are robust to rotation, translation, scaling, and to small changes in viewpoint. Feature detector 305 accepts as input a stereo image pair, and generates as output two sets of local feature points and their descriptors, one set for the left image and another set for the right image.

A feature matcher 310 finds matching pairs of local features of left and right images, by matching their feature descriptors in a one-to-one manner. Feature matcher 310 accepts as input two sets of local feature points and their descriptors, one set for the left image and another set for the right image, and generates as output point correspondences between the two images.

A correspondence selector 315 selects a number, N, of the matched features generated by feature matcher 310. Correspondence selector 315 accepts as input point correspondences between two images, and generates as output a subset of N corresponding points.

An outlier analyzer 320 calculates disparities for matched features. Outlier analyzer 320 accepts as input point correspondences between a left and a right image, and generates as output disparities therefor.

An outlier filter 325 filters the point correspondences generated by correspondence selector 315, and rejects correspondences with disparities that are significantly larger or significantly smaller than the disparities of a main group of correspondences. Outlier filter 325 accepts as input N point correspondences between a left and a right image, and generates as output a filtered set of point correspondences between the two images.

A correspondence subset selector 330 selects a number, N, of subsets of point correspondences, with replacement, from the total set of point correspondences generated by outlier filter 325. In one embodiment of the present invention, correspondence subset selector 330 selects subsets that form spatial patterns over the two images. Correspondence subset selector 330 accepts as input a set of point correspondences for a left and a right image, and generates as output N subsets of point correspondences between the two images.

A fundamental matrix generator 335 generates N candidate fundamental matrices, from the N subsets of point correspondences selected by correspondence subset selector 330. Fundamental matrix generator 335 accepts as input N subsets of point correspondences between a left and a right image, and generates N candidate fundamental matrices and N corresponding sets of point correspondences.

A fundamental matrix selector 340 ranks fundamental matrices and selects the one that best rectifies a left and right image pair. In one embodiment of the present invention, fundamental matrix selector 340 ranks by measuring co-linearity of epipolar lines between the two images.

In another embodiment of the present invention, fundamental matrix selector 340 ranks by use of matrix statistics. Fundamental matrix selector 340 accepts as input N candidate fundamental matrices, and N corresponding sets of point correspondences, and generates as output a rectification fundamental matrix and a corresponding set of point correspondences.

A homography generator 345 generates a pair of homographies that warp a left and right image pair such that their epipolar lines are aligned, and the images have minimal distortions. Nomography generator 345 accepts as input a rectification fundamental matrix and generates as output a pair of homographies.

A rectified image generator 350 warps a left and right image pair using a corresponding pair of homographies, and crops the warped images so that the results are rectangular pixel arrays. Rectified image generator 350 accepts as input a left and right image pair, and a corresponding pair of homographies, and generates as output a rectified and cropped pair of images.

### Disparity Map Initializer 400

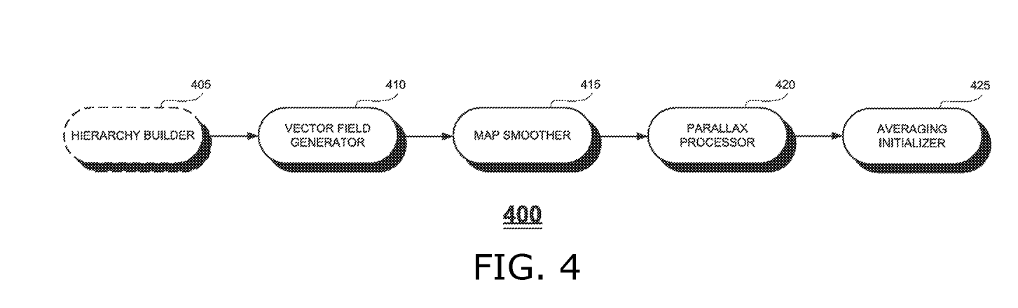

Reference is made to FIG. 4, which is a simplified block diagram of disparity map initializer 400, in accordance with an embodiment of the present invention. Disparity map initializer 400 determines a vector field that represents translations between corresponding blocks of a left and right image. As shown in FIG. 4, disparity map initializer 400 includes five modules.

A hierarchy builder 405 down-samples a stereo image pair to a lower resolution, a number, n, of times, and generates a hierarchy of stereo pairs, each level of the hierarchy being half of the resolution of its predecessor. Hierarchy builder 405 is of advantage in reducing processing time with minimal sacrifice of quality. As such, hierarchy builder is optional and is thus indicated by dashed lines in FIG. 4. Hierarchy builder 405 accepts as input a stereo image pair, and generates as output a hierarchy of stereo image pairs.

A vector field generator 410 performs block matching on lower resolution images of a hierarchy, and propagates the results to the next higher resolution images of the hierarchy. The block matching is summarized in a vector field that describes translations of each block in a stereo image pair. Vector field generator 410 accepts as input a hierarchy of stereo image pairs, and generates as output an initial disparity map represented as a vector field of translations within the stereo image pairs. It will be appreciated by those skilled in the art that block matching is but one of many possible procedures for finding an initial disparity map, and that other procedures for finding an initial disparity map may be used instead of disparity map initializer 400.

The initial disparity map generated by vector field generator 410 may contain noise and other artifacts. The noise may produce ghosting and other artifacts when re-rendering a scene according to a different vantage point. A disparity map smoother 415 avoids such unwanted effects by filtering the initial disparity map with one or more smoothing filters. Disparity map smoother 415 accepts as input an initial disparity map, and generates as output a smoothed disparity map.

A parallax processor 420 determines minimum and maximum parallax translations for a stereo image pair. Knowledge of minimum and maximum parallax is used in subsequent workflow processes. Parallax processor 420 accepts as input a vector field representing disparities between a left and right image of a stereo image pair, and generates as output minimum and maximum parallax translations that appear in the stereo image pair.

An averaging initializer 425 initializes averages at each pixel, by averaging the minimum and maximum parallax translations for the pixel values. Averaging initializer 425 accepts as input a smoothed disparity map, and generates as output a modified initial disparity map.

### Disparity Map Generator 500

Disparity map generator 500 is operable to generate a disparity map; i.e., a pixel correspondence map that relates pixels in the left and right input images that correspond to the same point in the scene, to each other. In one embodiment of the present invention, disparity map generation is based on a statistical model where stereo images are observations, and disparity values are hidden states.

Along these lines, disparity map generator 500 solves a Bayesian task in order to compute a disparity map estimate, d*. The estimate is formulated as a probabilistic labeling problem:

$${d}^{*} = {arg min}_{d ∈ D} {\sum }_{f} [ P ( f \vert X ) {\sum }_{r ∈ R} c ( f ( r ) , d ( r ) ) ] , \qquad ( 1 )$$

where R is a grid of pixel locations r, X is an aligned left-right image pair {Iₗ/Iᵣ} of input images, each image Iₗ and Iᵣ formally denoting a mapping from R to image color values, f is a label field f: R→K, where K is a finite set of labels corresponding to disparity values, D is a set of disparity maps, and c is a cost function that cumulatively penalizes local decision errors in f vis-á-vis the left-right image pair X. The rationale of Equation (1) is that given an observation, X, the disparity map, d*, is sought which is, on average, is closest to label fields, f, vis-á-vis the cost function c. “On average” is defined by the probability P(f|X) weighting; i.e., the disparity map d* has the property that label fields with high probability get low penalties, but label fields with low probability may get high penalties.

The labeling problem in Equation (1) is implemented by a Markov Random Field, incorporating a similarity measure for corresponding fragments in the left and right images, as well as a surface structure for the disparity map, according to:

$$P ( X , f ) = P ( X \vert f ) P ( f ) = \frac{1}{z} {\prod }_{r ∈ R} {q}_{r} ( f ( r ) ) {\prod }_{r , {r}^{′}} {g}_{{rr}^{′}} ( f ( r ) , f ( {r}^{′} ) ) , \qquad ( 2 )$$

where Z is a scale factor for normalization, qᵣ: K→ [symbol] is a potential function defining matching quality of respective fragments in left and right images for a given disparity label, f, resulting in P(X|f), and, for adjacent pixel locations r and r′, g_{r r′}:K×K→ [symbol] defines a surface structure, and yields the marginal probability P(f) of a label field, f. The functions qᵣ referred to as “data terms”, may correspond to local fragment correlation in left-right images, or sum of squares of color channel differences, or such other metric of goodness of fit. The functions g_{r r′}, referred to as “syntax terms”, impose smoothness restrictions upon the disparity map, to avoid, for example, occlusions and steep jumps in the disparity map.

One approach used to solve Equation (1) for the estimate, d*, is to calculate marginal probability distributions P(f(r)=k|X) for each label k ε K, and for each pixel r ε R, given X. The value of d* is then set based on these marginal probabilities, inter alia by taking an average value of P, or a maximum value of P. The marginal probabilities are approximated by

P(f(r)=k|X)≈Σ_{f:f}(r)=kP(X,f) (3)

for k ε K, which is performed by stochastic relaxation using a Gibbs sampler. Gibbs sampling serves to provide many label fields, f, and histogram statistics are gathered at each pixel location, r, regarding label values, k, that get assigned to r during relaxation. The estimate d* is obtained based on these probabilities as independent decisions at each pixel location r of R; i.e., the value of d* at pixel location r is independent of its values at neighboring pixels r′.

It has been observed that the histograms P(f(r)=k|X) quickly exhibit strong peaks, which correspond to a true disparity. As such, accumulating the histograms may be replaced by summing states that get assigned at each relaxation iteration, at each pixel location r, and normalizing the resulting sums.

The Markov Random Field of Equation (2) generalizes to derivation of disparity maps for a sequence of frames of a scene cut from a movie. The set, R, of pixel locations is extended into a third dimension by the time axis. A time-ordered collection of stereo frames is processed as whole pixel stereo volume.

Markov Random Field simulation operates by successively improving a disparity map, starting from an initial disparity map. Disparity map initializer 400 provides such an initial disparity map for disparity map generator 500.

It will be appreciated by those skilled in the art that the Bayesian decision approach with a Markov Random Field model is but one of many possible approaches for generating a disparity map, and that other stochastic approaches, and deterministic approaches may be used instead.

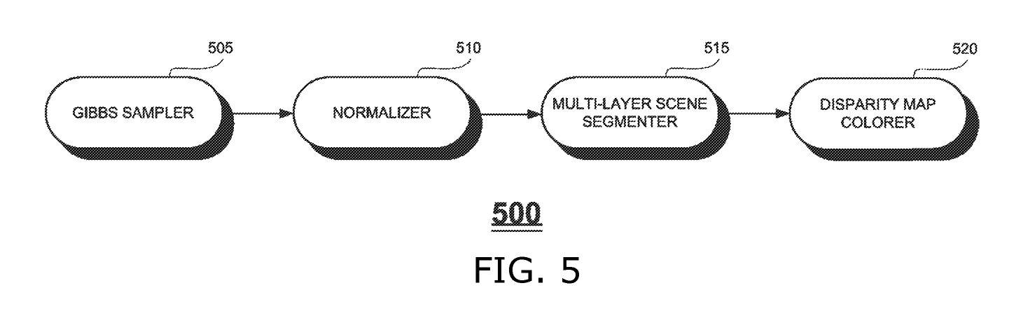

Reference is made to FIG. 5, which is a simplified block diagram of disparity map generator 500, in accordance with an embodiment of the present invention. As shown in FIG. 5, disparity map generator 500 includes four modules.

A disparity map may be interpreted as a joint probability distribution for left and right image channels. Along these lines, a Gibbs sampler 505 applies Monte Carlo sampling for locally correcting a disparity map. The Gibbs sampling proceeds for an adjustable total number of sampling steps, and terminates either when a quality criterion for the disparity map is achieved, or when the total number of sampling steps is reached. Gibbs sampler 505 accepts as input a disparity map, and generates as output an accumulated disparity map.

During the Gibbs sampling, disparity values are accumulated within a disparity map. A normalizer 510 normalizes the accumulated values according to the number of sampling steps that occur. Normalizer 510 accepts as input an accumulated disparity map, and generates as output an optimized disparity map.

A mufti-layer scene segmenter 515 decomposes the left and right images by grouping and removing objects, or parts of the scene, that violate an order constraint; i.e., two neighboring objects that appear left-to-right in one image and appear right-to-left in the other image. The removed pixels are painted white, to mark them as empty areas.

In one embodiment of the present invention, multi-layer scene segmenter 515 operates in a semi-automated mode. A user repeatedly draws a stroke across a foreground object and a stroke across a background object, in either the left or right image. Using these foreground and background samples, RGB vector quantization is performed to create clusters, by fitting Gaussians to cover objects colors and to cover background colors. Finally, a classification is used to segment the rest of the image into foreground and background, based on the foreground-background clusters thus created.

The decomposition results in various layers of non-intersecting stereo image pairs of the original image pair. Disparity maps are generated for these layers. View generator 700 subsequently renders these layers in back-to-front order, using only the non-white areas.

Multi-layer scene segmenter 515 accepts as input a disparity map, and generates as output a plurality of disparity maps—one for each layer.

A disparity map colorer 520 colors the segments generated by mufti-layer scene segmenter 515. Multi-layer scene segmenter 515 and disparity map colorer 520 are optional, and are thus indicated by dashed lines.

### Stereo 3D Adjuster 600

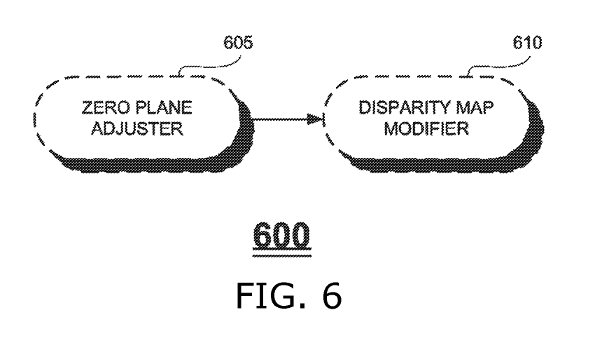

Reference is made to FIG. 6, which is a simplified block diagram of stereo 3D adjuster 600, in accordance with an embodiment of the present invention. Stereo 3D adjuster 600 enables adjusting a disparity map for perceived depths. As shown in FIG. 6, stereo 3D adjuster 600 includes two modules.

In some display environments it is desirable to be able to modify depth information, to achieve certain effects, such as changing the virtual plane that separates objects popping out of or objects popping into the viewing device. A zero plane adjuster 605 enables modification of scene information by modifying a disparity map. Zero plane adjuster 605 accepts as input a disparity map, and generates as output a modified disparity map.

In another embodiment of the present invention, zero plane adjuster 605 enables modification of scene information by shifting images with respect to one another. In this embodiment, zero plane adjuster 605 accepts as input a stereo image pair, and generates as output a modified stereo image pair.

A disparity map modifier 610 modifies a disparity map to achieve a desired depth effect, and saves the modification data in the disparity map, in addition to the unmodified disparity map. Alternatively, disparity map modifier 610 may save the modification data in a separate vector field, for subsequent use by view generator 700 as a second transform to be applied after a first transform, when view generator 700 creates a supplementary view. Disparity map modifier 610 accepts as input a disparity map representing a current scene, and generates as output a modified disparity map, or a modified disparity map and a modification request.

Disparity map modification is used to enhance a depth effect for some or all regions of an image. If a target viewing device has a different display size or a different number of views than the intended device that the images were captured for, then it may be of advantage to increase or decrease the overall depth effect within a scene. Alternatively, a depth effect may be modified for certain segments of the scene, or for certain objects in the scene. In one embodiment of the present invention, modification of depth effect for segments or objects in the scene is achieved by a computer-aided visual interactive procedure, in conjunction with view generator 700, to identify the segments or objects in the input images and disparity map.

Disparity map adjustments require various parameters, such as a minimum and a maximum disparity to achieve the desired depth effect. These parameters may be pre-set automatically, or set interactively in conjunction with view generator 700.

### View Generator 700

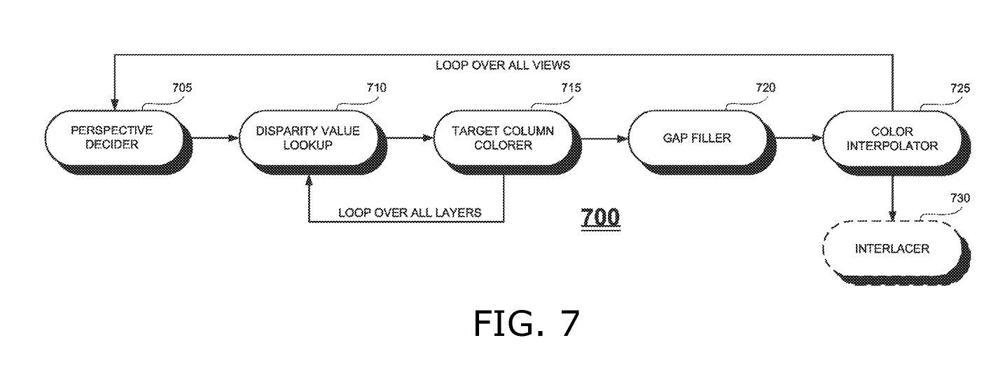

Reference is made to FIG. 7, which is a simplified block diagram of view generator 700, in accordance with an embodiment of the present invention. View generator 700 generates two-view stereoscopic 3D images, mufti-view stereoscopic 3D images, and interlaced stereoscopic 3D images.

Rendering of a mufti-view stereoscopic 3D image is performed per scan line. The pixel position within the view being generated is used for lookup in the disparity map. The value of the disparity map, and the current virtual position between the two images being interpolated, are used to appropriately mix the two images and generate a final pixel color value. When the disparity may was modified by disparity map modifier 610, or when the images have been segmented by mufti-layer scene segmenter 535, in-paint algorithms are used to fill problematic areas in the image caused by disparity map modifications or by monocular or invisible image areas.

Rendering of a two-view stereoscopic 3D image is similar to rendering of a multi-view image. Camera positions to be interpolated may be extended, to increase perceived depth effect, or shifted together, to decrease perceived depth effect. Alternatively, the perceived depth effect may be increased and decreased by using default left and right camera positions and a modified render algorithm with a modified disparity map as an input format.

Rendering of an interlaced stereoscopic 3D image is performed per pixel. In embodiments of the present invention, it is not necessary to generated complete images in advance, for mixing together into an interlaced image. Instead, it suffices to generate image data only as needed for pixel positions in the interlaced image.

As shown in FIG. 7, view generator 700 includes six modules.

A perspective decider 705 determines whether the target is a two-view or a mufti-view stereoscopic 3D image, and whether an inner image is to be rendered, or an outer image is to be rendered.

A disparity value lookup module 710 looks up a disparity map value, based on a pixel position within the view being rendered.

A target column colorer 715 determines pixel color within a current scan line by appropriately mixing the left image and the right image. Target column colorer 715 can process complete target images or an interlaced target image.

Modules 710 and 715 are applied repeatedly in an inner loop over all depth layers.

A gap filler 720 fills gaps in the input images and/or in the disparity map, if such gaps exist.

A color interpolator 725 applies neighborhood color interpolation.

Modules 710-725 are applied repeatedly in an outer loop over all views.

If an interlaced target is desired, then modules 710-725 are applied once, and an interlacer 730 is applied thereafter. Interlacer 730 interlaces the left and right images, and applies further color interpolation as appropriate. Interlacer 730 is shown in dashed lines as being optional, since it is only used when the target stereoscopic 3D image is an interlaced image.

### Processing a Video Sequence

As indicated above, the present invention is also of advantage in creating stereoscopic 3D movies. Processing consecutive stereo image pairs of a video sequence offers additional information to reduce or eliminate jitter and noise that occurs when processing individual stereo image pairs. In one embodiment of the present invention, disparity map generator 500 is operative to work on consecutive stereo image pairs, but processed in parallel.

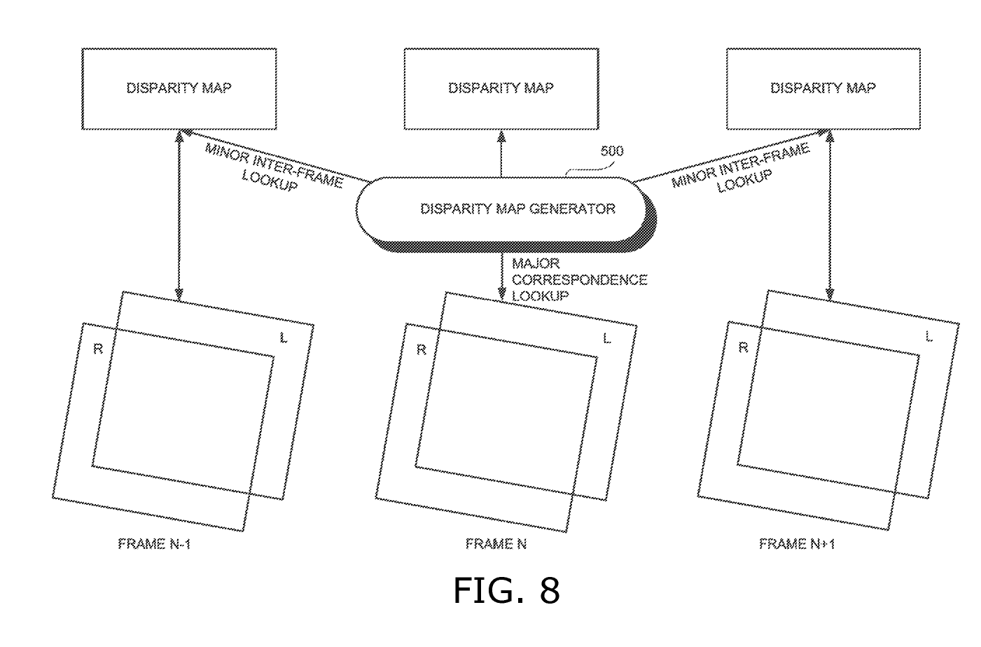

Reference is made to FIG. 8, which is a simplified diagram of processing a video sequence of stereo image pairs, in accordance with an embodiment of the present invention. When processing a video sequence, the Markov Random Field defined in Equation (2) above is modeled to operate on a stack of time-related disparity maps, and the potential functions, for also depend on disparity maps of previous and successive frames to assign a quality metric. In turn, this results in improved relaxation of consecutive disparity maps as time advances.

FIG. 8 shows disparity map generation over a succession of three frames; namely, FRAME N−1, FRAME N and FRAME N+1, with focus on FRAME N. It will be appreciated by those skilled in the art that a different number of frames may be processed as shown in FIG. 8, and the number of frames processed is limited only by computing resources and the total number of frames in the video sequence.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A system for creation of stereoscopic 3D images, comprising:
a disparity map initializer, for deriving one or more initial disparity maps represented as vector fields of translations between aligned left and right images of a scene;
a disparity map generator, coupled with said disparity map initializer, for deriving disparity maps for the aligned left and right images, from the initial disparity maps; and
a view renderer, coupled with said disparity map generator, for rendering stereoscopic 3D images, from the aligned left and right images, and from the disparity maps.

2. The system of claim 1 wherein said disparity map initializer segments the derived initial disparity maps into depth related layers.

3. The system of claim 1 further comprising an image pre-processor, coupled with said disparity map initializer, for performing at least one of (i) balancing captured left and right images of the scene, (ii) reducing noise in captured left and right images of the scene, (iii) correcting for chromatic aberration in captured left and right images of the scene, (iv) correcting for vignettes in captured left and right images of the scene, and (v) correcting for lens distortion in captured left and right images of the scene.

4. The system of claim 1 further comprising an image rectifier, coupled with said disparity map initializer, for deriving homography matrices for non-aligned left and right images of the scene, and for generating the aligned left and right images therefrom.

5. The system of claim 4 wherein said image rectifier matches detected features of the non-aligned left and right images of the scene.

6. The system of claim 1 wherein said disparity map generator applies an optimization process over potential image region correspondences or potential image element correspondences, to generate disparity map values.

7. The system of claim 6 wherein said disparity map generator operates on a stack of time-related left and right images of the scene.

8. The system of claim 6 wherein said disparity map generator applies random Gibbs sampling to estimate disparity map values.

9. The system of claim 1 wherein said view renderer renders stereoscopic 3D images in a plurality of formats.

10. The system of claim 1 further comprising a stereo 3D adjuster, coupled with said disparity map generator and with said view generator, for modifying the derived disparity maps for the aligned left and right images, to alter the overall depth perception or to adjust the relative depth of distinct objects in the scene.

11. A method for creating stereoscopic 3D images, comprising:
deriving initial disparity maps represented as vector fields of translations between aligned left and right images of a scene;
deriving disparity maps for the aligned left and right images, from the initial disparity maps; and
rendering stereoscopic 3D images, from the aligned left and right images, and from the derived disparity maps.

12. The method of claim 11 further comprising segmenting the derived initial disparity maps into depth related layers.

13. The method of claim 11 further comprising at least one of:
(i) balancing captured left and right images of the scene;
(ii) reducing noise in captured left and right images of the scene;
(iii) correcting for chromatic aberration in captured left and right images of the scene;
(iv) correcting for vignettes in captured left and right images of the scene; and
(v) correcting for lens distortion in captured left and right images of the scene.

14. The method of claim 11 further comprising:
computing homography matrices for non-aligned left and right images of the scene; and
generating the aligned left and right images therefrom.

15. The method of claim 14 wherein said rectifying comprises matching detected features of the non-aligned left and right images.

16. The method of claim 11 further comprising applying an optimization process over potential image region correspondences or potential image element correspondences, to generate disparity map values.

17. The method of claim 11 wherein said generating disparity maps comprises operating on a stack of time-related aligned left and right images of the scene.

18. The method of claim 11 wherein said deriving a disparity map comprises applying random Gibbs sampling to estimate disparity map values.

19. The method of claim 11 wherein said rendering renders stereoscopic 3D images in a plurality of formats.

20. The method of claim 11 further comprising modifying the derived disparity maps for the aligned left and right images, to after the overall depth perception or to adjust the relative depth of distinct objects in the scene.
